(19) United States
(12) Patent Application Publication
(10) Pub. No.: US 2013/0284587 A1
(43) Pub. Date: Oct. 31, 2013

(54) OZONE AND PLASMA GENERATION USING ELECTRON BEAM TECHNOLOGY

(71) Applicant: Kaveh Bakhtari, Cambridge, MA (US)

(72) Inventor: Kaveh Bakhtari, Cambridge, MA (US)

(73) Assignee: HITACHI ZOSEN CORPORATION, Osaka (JP)

(21) Appl. No.: 13/993,594

(22) PCT Filed: Dec. 16, 2011
(86) PCT No.: PCT/US11/65523

§ 371 Date: Jul. 8, 2013

Related U.S. Application Data
(60) Provisional application No. 61/423,693, filed on Dec. 16, 2010.

(51) Int. Cl. B01J 19/08

(52) U.S. Cl. CPC B01J 19/085
USPC 204/157.44; 422/186

(57) ABSTRACT

This invention proposes, among other things, systems and methods for providing ozone generators or plasma generators that generate an electric field in an electron generation chamber that is separate from a reaction chamber. An electron beam emitter in an electron generation chamber is configured to emit a beam of electrons and is separated from the reaction chamber by an electron permeable barrier that provides a window through which the beam of electrons passes. The electrons are accelerated to the required energy in the electron generation chamber and transmitted through the barrier to the reaction chamber, where an input gas source introduces an input gas into the reaction chamber. The input gas may react with the beam of electrons inside the reaction chamber to form an output gas comprising a plasma or a concentration of ozone, and the output gas passes from the reaction chamber to a wafer processing chamber.

### REFERENCE TO RELATED APPLICATIONS

This application claims priority under 35 U.S.C. §119 to U.S. Provisional Patent Application 61/423,693, entitled “Ozone and Plasma Generation Using Electron Beam Technology,” filed Dec. 16, 2010, which is incorporated herein in its entirety.

### FIELD OF THE INVENTION

In general, the invention relates to systems and methods for generating ozone and plasma using electron beam technology.

### BACKGROUND

Ozone and plasma generation technologies rely on the principle of supplying energy to an input gas, resulting in the formation of charge carriers (electrons and ions) as well as additional plasma species. The most commonly used method for generating and sustaining ozone and plasma for industrial applications is by applying an air electric field to the input gas. There are several methods for generating and applying an electric field for these applications. Typically, ozone a id plasma gene ion technologies are configured in such way that the electric field is generated in the same chamber in which the input process gas is reacted. There are fundamental limitations of generating the electric field in the same chamber as where the input process gas is dissociated into ozone or plasma. One limitation is that the reacted gas can modify the surface of the chamber in such a way as to alter the way in which the electric field is generated, resulting in a change in reaction efficacy. A second limitation is that the reacted gas can modify the surface of the chamber in such a way as to create additional unwanted particles. A third limitation is that it is difficult or impossible to precisely control how the electric field interacts with the process gas, limiting the flexibility of the process. Known processes for overcoming these limitations for ozone and plasma generation generally result in reduced efficacy, higher process variability, lower efficiency, increased system complexity, higher cost, and increased system maintenance.

Ozone generation technologies currently exist and have been in commercial operation or over 20 years. Applications include semiconductor manufacturing (including without limitation atomic layer deposition, oxide growth, photo-resist removal, and chemical vapor deposition) and water treatment. The typical configuration of ozone generation for semiconductor applications uses dielectric barrier discharge to create an electric field in a reaction chamber that initiates a dissociation reaction through electron acceleration within an input gas containing some concentration of oxygen. This initiates a capacitively coupled plasma and yields some concentration of ozone. In this type of arrangement, the electric field is created in the same chamber in which the input gas is reacted.

One common configuration for dielectric barrier discharge is metal to ceramic discharge cells. In order to increase the concentration of ozone produced in these types of embodiments, refractory metals such as tungsten are a choice of material for the metal surface. One limitation is the detrimental modification of the discharge surface as a result of resultant process gas (i.e. ozone) interaction with those surfaces. A result of this gradual detrimental modification is the gradual reduction in concentration of the ozone generated due to loss of the effective discharge surface. Conventional methods of ozone generation also require precise control of the discharge gap in the reaction zone and require cooling of the reaction zone as the ozone concentration is dependent on the temperature of the reaction zone volume and discharge surfaces. Precise gap control and cooling introduce complexity to the overall design of the system and variability in the resultant process gas across different systems. In addition, precise gap control allows for only limited control over the energy levels of the electrons.

The industry standard for plasma generation is based on either inductively coupled plasma generation or microwave plasma generation. Examples of industrial plasma generated in these methods include generation of fluorine based plasma, oxygen or nitrogen plasma, water plasma, argon or another inert gas plasma, and hydrogen plasma. These types of plasmas are used for a wide range of semiconductor and other industrial applications including without limitation: photoresist removal, passivation and residue removal, surface modification, nitridation, oxide etch, deposition, silicon etch, and remote plasma cleaning of reaction chamber. Common materials used in these plasma generation technologies include quartz, sapphire, and anodized aluminum for inductively coupled plasma. For capacitively coupled plasma, common materials include alumina or tungsten, and microwave plasma generation commonly uses sapphire or aluminum nitride.

Conventional methods of plasma generation generate a high electromagnetic field within the reaction chamber that accelerates electrons and initiates an avalanche of electron generation that breaks down an input process gas into a plasma. As a result of having the electromagnetic field present within the reaction chamber, the electromagnetic field influences the resultant plasma, causing direct interactions of the ions and charged particles with the walls of the chamber such as etching the walls and generating additional particles. These additional particles are problematic for semiconductor and other industries. Furthermore, conventional methods result in only partial control over the energy levels of the electrons.

As such, there remains a need in the art for improved systems and methods for ozone and plasma generation.

### SUMMARY

The systems and methods described herein include, among other things, systems and methods for providing ozone generators or plasma generators that generate an electric field in an electron generation chamber that is separate from a reaction chamber. An electron beam emitter in an electron generation chamber is configured to emit a beam of electrons. The electron generation chamber is separated from the reaction chamber by an electron permeable barrier that provides a window through which the beam of electrons passes. The barrier also seals the electron generation chamber to prevent non-electron material from passing out of the electron generation chamber and to maintain a differential pressure and a vacuum level. The electrons are generated, accelerated to the appropriate energy in the electron generation chamber, and transmitted through the barrier to the reaction chamber, where an input gas source introduces an input gas into the reaction chamber. The input gas may react with the beam of electrons inside the reaction chamber to form an output gas comprising a plasma or ozone, and the output gas passes from the reaction chamber to a wafer processing chamber.

in one embodiment, the system includes an electron beam emitter having an electron generation chamber. The electron beam emitter is configured to emit a beam of electrons and has a barrier at one end of the electron generation chamber. The barrier comprises an electron permeable material to provide a window through which the beam of electrons passes and which seals the electron generation chamber to prevent material from passing out of the electron generation chamber. The barrier maintains a differential pressure and a vacuum level. A reaction chamber is arranged proximate the barrier for receiving the beam of electrons and has a passage for allowing a gas to flow therethrough. An input gas source introduces an input gas into the reaction chamber, whereby the input gas may react with the beam of electrons inside the reaction chamber to form an output gas comprising a reactive gas in a form of plasma or a concentration of ozone. The output gas passes from the reaction chamber to a wafer processing chamber. By separating the electron generation chamber from the reaction chamber, the systems and methods described herein are understood to allow for better control over the distribution of electron energy levels by the electron beam emitter, thereby allowing for better control over the resultant output gas. In addition, several embodiments describe a number of physical features that provide further control over the distribution of electron energy levels. However, these embodiments are provided for illustration purposes only and are not to be deemed limiting to the scope of the invention.

More particularly, the systems and methods described herein include systems for generating a plasma or ozone, comprising an electron beam emitter having an electron generation chamber, configured to emit a beam of electrons, and having a barrier at one end of the electron generation chamber. The barrier may comprise an electron permeable material to provide a window through which the beam of electrons passes and which seals the electron generation chamber to prevent material from passing out of the electron generation chamber and maintains a differential pressure and a vacuum level. The system may also include a reaction chamber arranged proximate the barrier for receiving the beam of electrons and having a passage for allowing a gas to flow therethrough. Additionally, the system may have an input gas source for introducing an input gas into the reaction chamber. Typically the system allows the input gas to react with the beam of electrons inside the reaction chamber to form an output gas comprising a reactive gas in a form of plasma or a concentration of ozone, and the output gas passes from the reaction chamber to a wafer processing chamber.

Optionally, the system may further include a controller for controlling a current and an accelerating voltage of the electron beam emitter to manipulate characteristics of the beam of electrons to achieve a selected energy distribution inside the reaction chamber. Further optionally, the system may have a second electron beam emitter configured to emit a second beam of electrons that passes into the reaction chamber, and optionally a cooling channel configured to adjust the temperature inside the reaction chamber. A secondary electron generator may be added and arranged to block a path of the beam of electrons and generate secondary electrons. Other modifications may be made without departing from the scope thereof.

In another aspect, the invention provides methods for generating a plasma or ozone. The methods may include emitting, an electron beam emitter having an electron generation chamber, a beam of electrons across a barrier arranged at one end of the electron generation chamber, wherein the barrier comprises an electron permeable material, provides a window through which the beam of electrons passes, seals the electron generation chamber to prevent material from passing out of the electron generation chamber, and maintains a differential pressure and a vacuum level. The methods may also include the step of introducing, by an input gas source, an input gas into a reaction chamber arranged proximate the barrier for receiving the beam of electrons, whereby the input gas may react with the beam of electrons inside the reaction chamber to form an output gas comprising a plasma or a concentration of ozone. The output gas may be passed from the reaction chamber into a wafer processing chamber, or other suitable equipment.

The methods may further include controlling a current and an accelerating voltage of the electron beam emitter to manipulate beam characteristics to achieve a selected energy distribution inside the reaction chamber. Optionally, the method may further include emitting, by a second electron beam emitter, a second beam of electrons that passes into the reaction chamber. Further optionally, the method may include adjusting, by a cooling channel, the temperature inside the reaction chamber. The method may also include blocking, by a secondary electron generator, a path of the beam of electrons, thereby generating secondary electrons. Other modifications may be made without departing from the scope thereof.

### BRIEF DESCRIPTION

The above and other features of the present disclosure, including its nature and its various advantages, will be more apparent upon consideration of the following detailed description, taken in conjunction with the accompanying drawings in which:

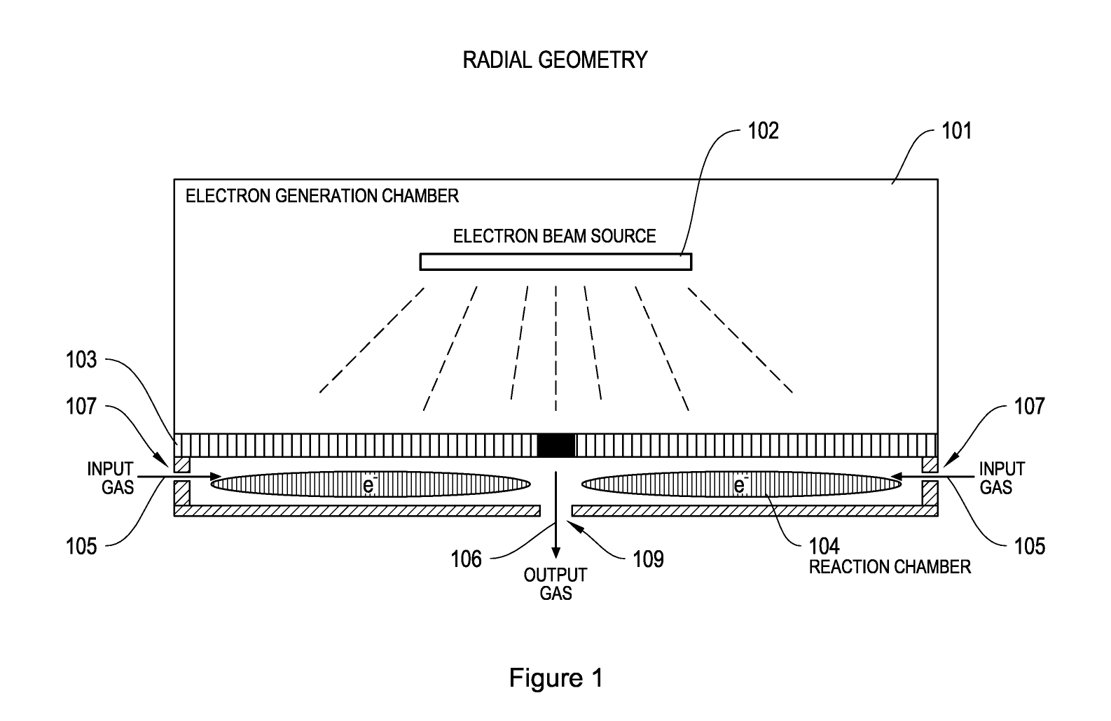

FIG. 1 illustrates one embodiment of a device using radial geometry as described herein for generating ozone or plasma where the electron generation chamber is separate from the reaction chamber, in which there are two input channels and one output channel in the reaction chamber;

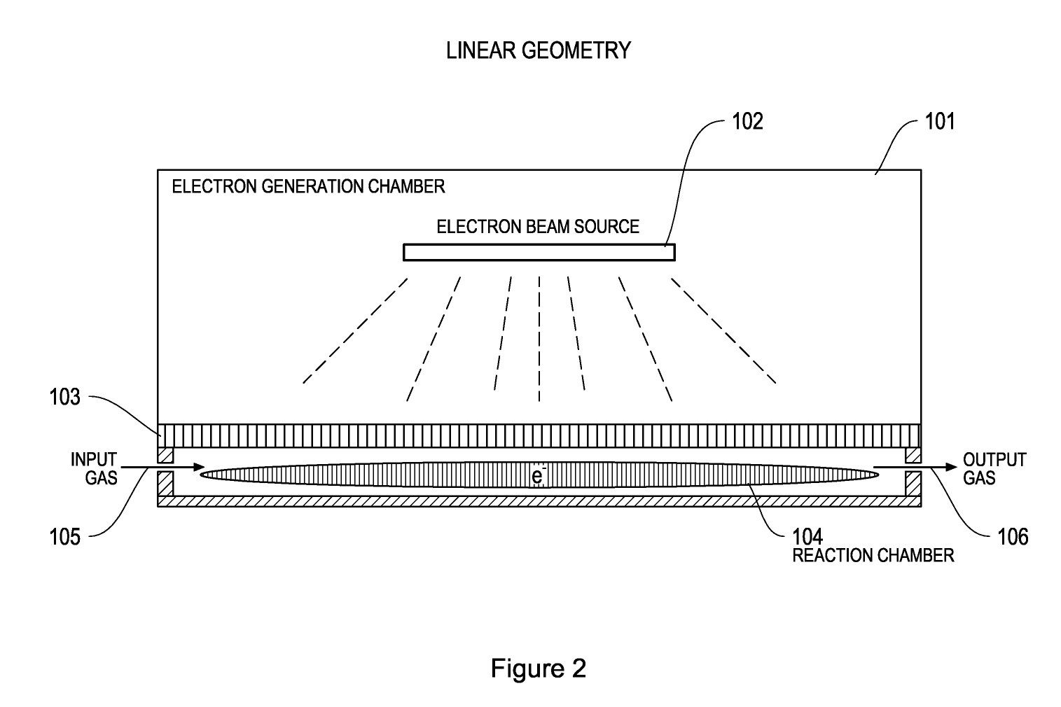

FIG. 2 illustrates an alternate embodiment of a device using linear geometry for generating ozone or plasma, in which there is one input channel and one output channel in the reaction chamber;

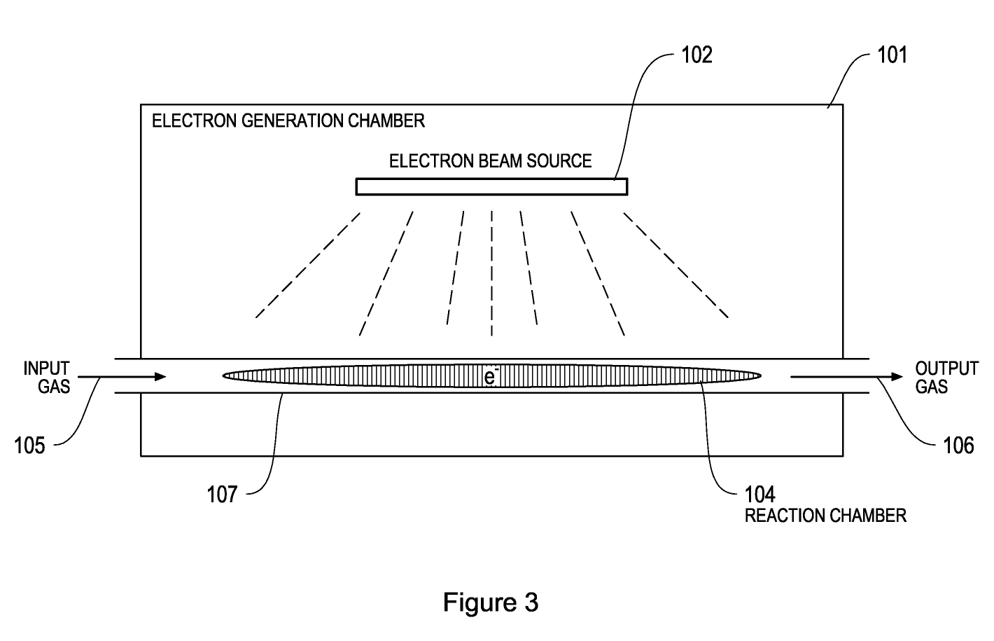

FIG. 3 illustrates a further embodiment of a device for generating ozone or plasma, in which the process gas flows through a thin walled tube;

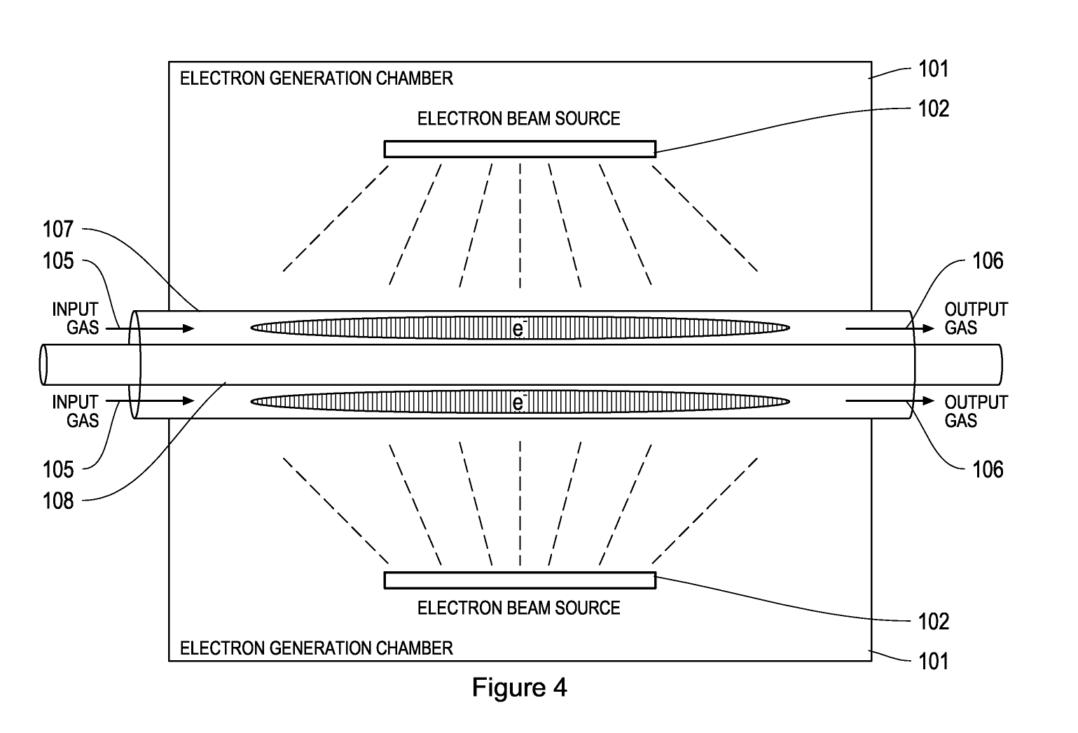

FIG. 4 illustrates a further embodiment of a device for generating ozone or plasma, in which there are two electron beam sources;

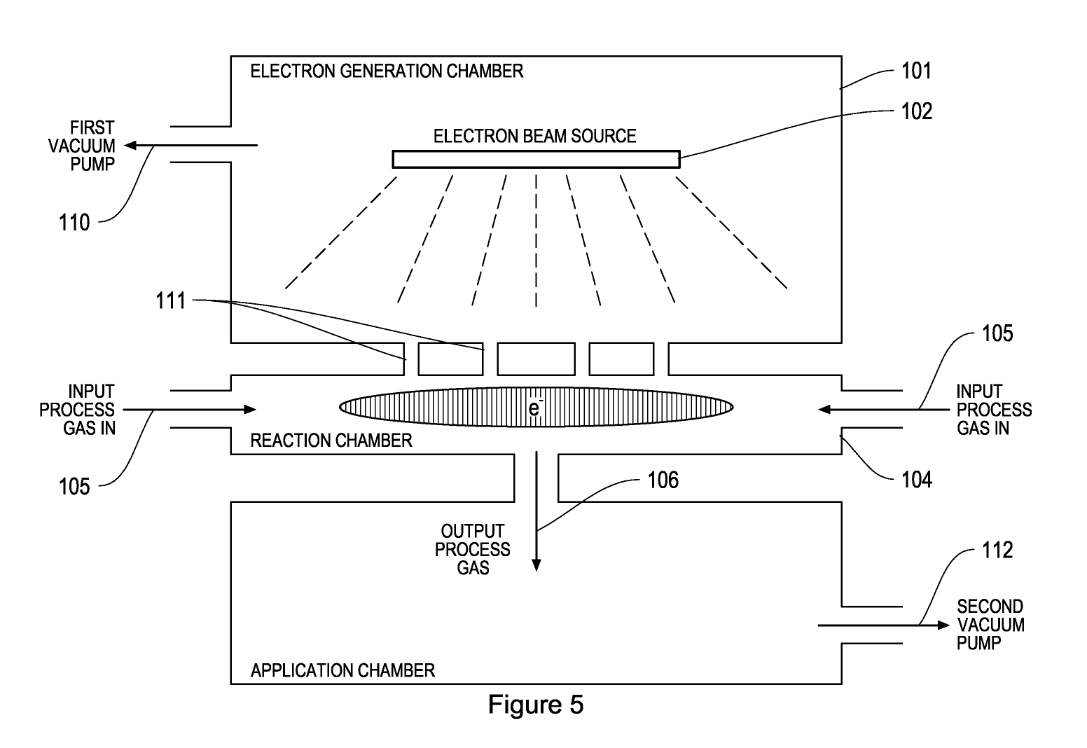

FIG. 5 illustrates a further embodiment of a device for generating ozone or plasma, in which the barrier separating the electron generation chamber and the reaction chamber includes apertures;

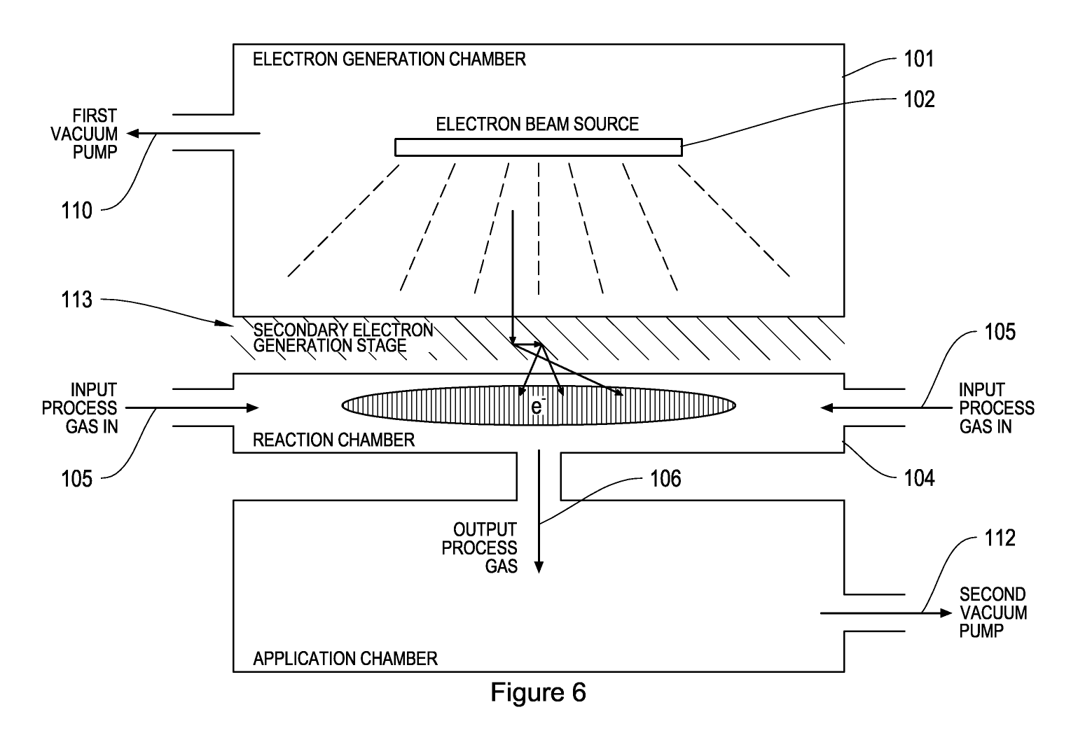

FIG. 6 illustrates a further embodiment of a device for generating ozone or plasma, in which the barrier separating the electron generation chamber and the reaction chamber includes a secondary electron generating stage;

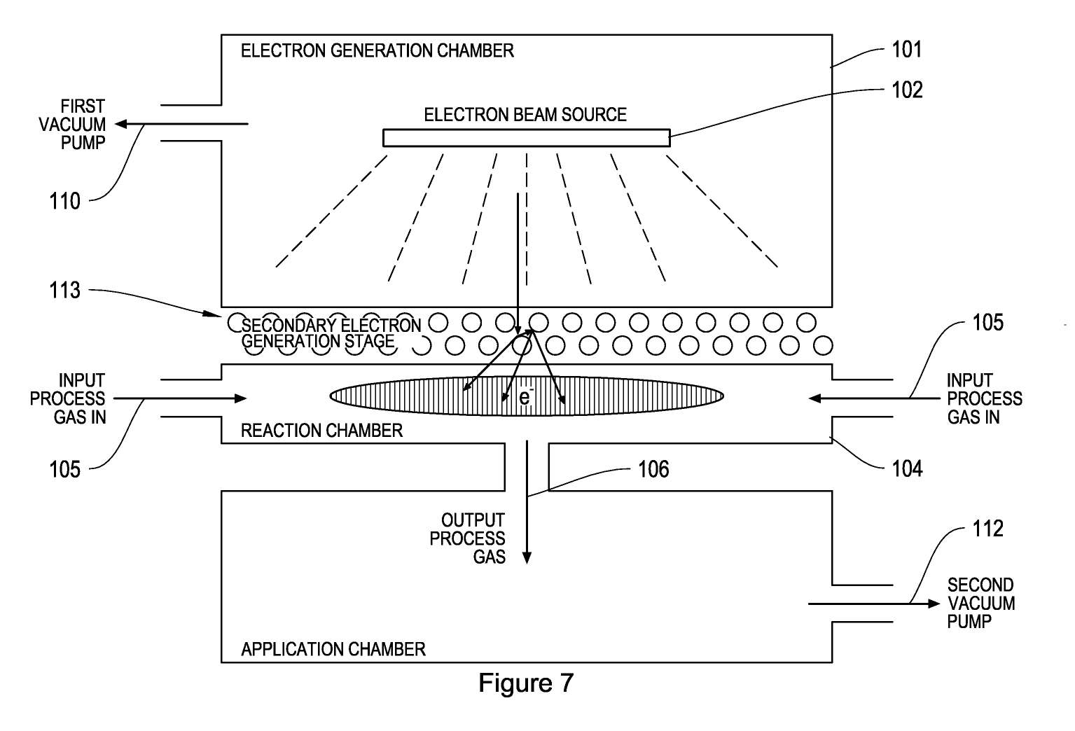

FIG. 7 illustrates a further embodiment of a device for generating ozone or plasma, in which the barrier separating the electron generation chamber and the reaction chamber includes a secondary electron generating stage; and

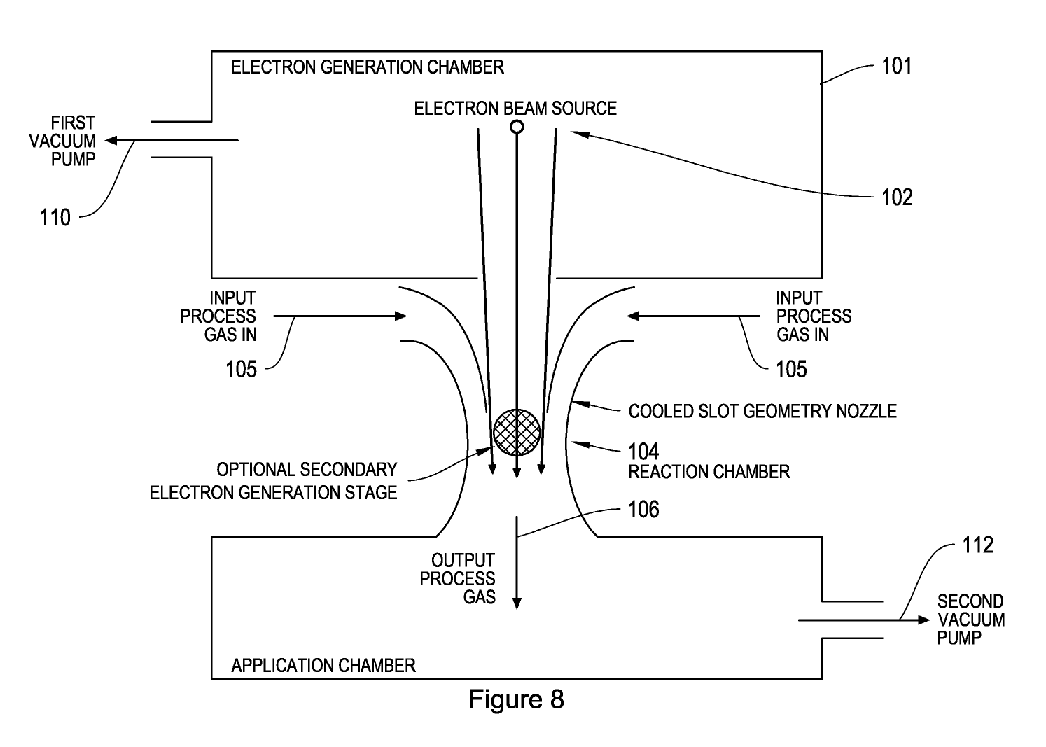

FIG. 8 illustrates a further embodiment of a device for generating ozone or plasma, in which electrons are introduced into the reaction chamber through a nozzle.

### DETAILED DESCRIPTION OF CERTAIN ILLUSTRATIVE EMBODIMENTS

To provide an overall understanding of the systems and methods described herein, certain illustrative embodiments will now be described, including a system for constructing ozone or plasma generators that create an electric field in a separate chamber from the reaction chamber. For illustrative purposes, the systems and methods described herein are discussed with reference to providing gas to a wafer processing system. However, it will be understood by one of ordinary skill in the art that the systems and methods described herein may be adapted and modified as is appropriate for the application being addressed and that the systems and methods described herein may be employed for many suitable applications, and that the systems and methods may have other additions and modifications will not depart from the scope thereof.

FIG. 1 illustrates one embodiment of a device 100 using radial geometry for generating ozone or plasma. FIG. 1 illustrates the device 100 having an electron generation chamber 101, a reaction chamber 104, a vacuum window 103, an electron beam source 102, an input gas 105 and an output gas 106. FIG. 1 illustrates the device 100 where the electron generation chamber 101 is separate from the reaction chamber 104, in which there are two input channels and one output channel in 109 the reaction chamber 104. FIG. 1 shows an input process gas 105 flowing into two input channels 107 and reacting to produce a reacted output gas 106, which exits the reaction chamber 104 through output channel 109. A barrier that separates the electron generation chamber 101 from the reaction chamber 104 includes the vacuum window 103. The barrier is positioned at one end of the electron generation chamber 101, and the reaction chamber 104 is arranged proximate the barrier. The vacuum window 103 may be formed of thin metallic foil such as titanium. Such a thin foil may be electron permeable to allow electrons to pass through the vacuum window 103 and into the reaction chamber. The vacuum window 103 may be formed using any suitable technique, and one such suitable technique is described in European patent 11949441B1, which among other things, describes an electron emitter having a chamber sealed at one end by an exit window made of a thin metallic foil of suitable material such as titanium, magnesium, alumina or any other suitable material. The contents of European patent 1194944B1 are hereby incorporated by reference in their entirety.

The electron beam source 102 is an electron beam emitter, which is configured to emit a beam of electrons. Typically, the electron beam source 102 is a filament, such as a tungsten wire filament, but any suitable electron source, including a plate, grid or other element may be used. The beam of electrons is generated within the electron generation chamber that is kept at an appropriate level of vacuum, typically at pressures below 1E-4 Torr. A low pressure within the electron generation chamber may be necessary for the electron beam source 102 to generate a beam of electrons with high energy levels.

A controller may control the characteristics of the beam of electrons by manipulating a current and an accelerating voltage in such a way to achieve a desired energy distribution. For example, the controller may be a device external to the electron beam source 102, or the controller may be within the electron beam source 102. The controller may manipulate the electron beam current to be on the order of 100 mA, and the accelerating voltage to be on the order of 100 kV. The desired energy distribution may be selected based on what energy levels are required for a particular plasma mix and a required process gas. The energy is transmitted from the electron generation chamber 101 to the reaction chamber 104 through the vacuum window 103.

The pressure in the reaction chamber 104 is much higher (on the order of 1-10 Torr for plasma and 10-50 psi for ozone) than the pressure in the electron generation chamber 101 (below 1E-4 Torr). The reaction chamber 104 requires a higher pressure based on the process requirement for the output gas 106. The vacuum window 103 allows for this differential pressure between the two chambers.

Dimensions of the reaction chamber 104 are not fixed and may be driven primarily by the cost and throughput requirements. As an example, the dimensions of the reaction chamber 104 may be 500 mm×250 mm×100 mm, or some other set of suitable dimensions. Furthermore, the walls of the reaction chamber 104 may include more plasma resistant material, as the material is not restricted to dielectric materials or specific metals as is required and common in previous technologies. An advantage of device 100 over the previous technology is device 100 has fewer restrictions regarding the choice of material. For example, common vacuum compatible material such as stainless steel may be used in device 100.

Input process gas 105 is introduced by one or more input gas sources from two input channels 107 positioned on opposite ends of the reaction chamber 104. Examples of input gases are NF₃, N₂, O₇, Ar, H₂0 vapor, H₂, CF₄, or He. The dimensions of the input channels are not critical parameters for the overall function of the device 100. The input process gas 105 travels along the length of the reaction chamber 104 towards the middle at a flow rate on the order of 10 SLM (Standard Liters a Minute). In addition, the device of FIG. 1 may have multiple channels at lower flow rates or a single channel at a higher flow rate. As it travels along the length of the reaction chamber 104, the input process gas 105 reacts with the electrons from the electron beam source 102 to produce an output gas 106.

Depending on the type of reaction, the output gas 116 may include plasma or ozone and is passed from the reaction chamber through a output channel 109 in the middle of the reaction chamber 104 into a downstream site for an industrial process such as a wafer processing chamber. The dimensions of the output channel are not critical parameters for the overall function of the device 100. A solid feature (not labeled in FIG. 1, but illustrated herein) is used to block the beam in a specific location so as to control the distribution energy entering the process zone. Physical features may be arranged and positioned to control the energy distribution in such a way so as to optimize ozone or plasma generation for a specific purpose or application. One location may be at the ozone output where the high energy electrons could increase rate of dissociation and destruction of ozone.

Device 100 overcomes the limitations of conventional methods of ozone or plasma generation and presents multiple advantages. First, as a result of separating the electron beam chamber 101 from the reaction chamber 104, the electric field in the electron beam chamber 101 is not affected by changes in surface properties of the reaction chamber 104. This effectively removes a primary cause for the decay in concentration of the output gas 106. Another advantage is that the device 100 enables significant control of the distribution of electron energy levels. This allows for the process parameters, such as flow rate and output gas concentration, to be optimized. These are key parameters for semiconductor and other industrial applications.

As a third advantage, the output gas 106 is less influenced by the electric field, reducing the interaction between the output gas 106 and the walls of the reaction chamber 104. Fourth, the device 100 does not require precise gap control, which adds to the complexity and variability in conventional devices. Thus, the device 100 produces more consistent resultant output gases. Fifth, the source of electromagnetic energy does not interact directly with gas ions and ionized particles in the plasma, thereby decreasing the number of particles created. Sixth, the design does not require dielectric material for the chamber walls, enabling the use of more plasma resistant materials, further decreasing the number of generated problematic particles. A seventh advantage is that, the shape of the reaction chamber has no limitations, allowing for use of a straight channel. This provides a straight flow path for unperturbed reactive gas flow that eliminates interaction with the walls and particle generation. This is not the case for conventional plasma sources such as inductively coupled sources, where the choice of channel shape is driven by the induction coupling requirement and results in a flow channel that results in wall damage and particle generation through flow-channel interaction. Finally, a wider range of material can be selected for constructing the reaction chamber walls, leading to possible savings in cost and allowing for a wider range of selected precursors for the input gas.

FIG. 2 illustrates a device using linear geometry for generating ozone or plasma where the electron generation chamber 101 is separate from the reaction chamber 104, in which there is one input channel and one output channel in the reaction chamber 104, according to an illustrative embodiment of the invention. The device of FIG. 2 operates identically to the operation of the device of FIG. 1, with the exception that instead of having two input channels, the device of FIG. 2 has a single input channel at one end of the reaction chamber 104. The input gas 104 is introduced from the input channel, flows linearly along the length of the reaction chamber 104, and reacts with the electrons from the electron beam source 102 to produce an output gas 106. The reacted output gas 105 is released from the reaction chamber 104 through an output channel at an end opposite to the input channel and into a downstream site for an industrial process such as wafer processing.

FIG. 3 illustrates a device for generating ozone or plasma where the electron generation chamber 101 is separate from the reaction chamber 104, in which the process gas flows through a thin walled tube 107, according to an illustrative embodiment of the invention. The device of FIG. 3 operates identically to the operation of the device of FIG. 2, with the exception that the barrier separating the electron generation chamber 101 and the reaction chamber 104 is a wall of a thin wall-d tube 107. The input gas 105 is introduced into the reaction chamber 104 through the thin walled tube 107. This thin walled tube consists of two components: a structural thicker wall with holes and slots and a thin walled layer held structurally by the first component that allows for electron passage.

FIG. 4 illustrates a device for generating ozone or plasma, in which there are two elect beam sources 102. The device of FIG. 4 operates identically to the operation of the device of FIG. 3, with the exception that the device of FIG. 4 has two electron beam sources 102 and two concentric tubes: one thin walled 107 and one for water cooling 108. The two electron beam sources 102 are positioned on opposite sides of the thin walled tubes 107 and generate and transmit energy to the thin walled tube 107 in the same way as described in relation to FIG. 1. A cooling channel 108 runs through the center of the thin walled tubes 107 in order to adjust the temperature within the reaction chamber.

The devices of FIGS. 1-4 illustrate embodiments for generating ozone or plasma in which the electron beam source primarily determines the distribution of electron energy levels in the reaction chamber to control the concentration of ozone or plasma in the output gas. This energy distribution can also be controlled through a variety of means, including a number of physical features that can further control the distribution of energy introduced to the reaction chamber.

FIG. 5 illustrates a device for generating ozone or plasma, in which the barrier separating the electron generation chamber 101 and the reaction chamber 104 has apertures 111, according to an illustrative embodiment of the invention. The device of FIG. 5 operates identically to the operation of the device of FIG. 1, with the exception that the device of FIG. 5 includes a barrier with apertures 111 and two vacuum pumps 110 and 112. The electron beam source 102 is generated within the electron generation chamber 101, which is kept at an appropriate level of vacuum through the use of a first vacuum pump 110. The electrons generated by the electron beam source 102 are transmitted to the reaction chamber 104 through the apertures 111 in the barrier. The controller manipulates the beam characteristics by controlling the current and accelerating voltage values. Due to the apertures in the barrier, the device of FIG. 5 requires lower voltages (on the order of 100V-1000V) than those required by the device in FIG. 1. Input process gas 105 is introduced into the reaction chamber 104 at opposite ends of the reaction chamber 104. As the input process gas 105 travels along the length of the reaction chamber 104 towards the middle, the input process gas 105 reacts with the electrons from the electron beam source 102 to produce an output process gas 106. The reacted output process gas 106 is released from the reaction chamber through an output channel in the middle of the reaction chamber 104. The downstream site is an application chamber, which is for an industrial process such as wafer processing. A second vacuum pump 112 is positioned downstream from the reaction chamber 104 and creates a differential pressure between the electron generation chamber 101 and the reaction chamber 104 that causes the process gas to flow through the reaction chamber.

In some embodiments, the electron generation chamber 101 is an ultra high vacuum level, and the reaction chamber 104 is a substantially higher pressure. For the electrons generated by the electron beam source 102 to pass through the barrier to enter the reaction chamber 104, the electrons need to achieve at least a minimum energy level. The energy distribution of the electrons within the reaction chamber 104 defines the flow rate and concentration of the resultant output process gas 106. One method for controlling this energy level is to use the two vacuum pumps 110 and 112 to create differential pressure that causes the process gas to flow through the system. In this case, there is no need for a vacuum window as described in relation to FIG. 1, thereby removing the requirement for the electrons to achieve a minimum energy level in order to pass through the barrier between the electron generation chamber 101 and the reaction chamber 104.

FIG. 6 illustrates a device for generating ozone or plasma, in which the barrier separating the electron generation chamber 101 and the reaction chamber 104 includes a secondary electron generating stage 113, according to an illustrative embodiment. The device of FIG. 6 operates identically to the device of FIG. 5, with the exception that instead of having apertures in the barrier separating the electron generation chamber 101 from the reaction chamber 104, the barrier includes a secondary electron generating stage 113. The secondary electron generating stage 113 includes a set of louvers that block a path of the beam of electrons and generate surface collisions between the beam of electrons and the louvers. The angles of the louvers are designed to control the number of surface collisions between the electrons louvers before the electrons reach the reaction chamber 104. The primary electrons exiting the electron generation chamber 101 interact with the secondary electron generation stage 113, generating secondary electrons with lower energy than the primary electrons. These secondary electrons then react with the input gas 105 in the reaction chamber 104 to dissociate the gas into the desired plasma or ozone. A benefit of using the secondary electron generating stage 113 is that the device of FIG. 6 allows for further control of the distribution of electron energy levels introduced into the reaction chamber 104. In this way, the concentration of the generated ozone or plasma in the output gas 106 can be further controlled by manipulating elements of the secondary electron generating stage 113.

As described in relation to FIG. 1, the characteristics of the electron beam can be controlled by manipulating current and accelerating voltage in such a way to optimize the energy required for a chemical reaction. The controller may manipulate the electron beam current to be on the order of 100 mA, and the accelerating voltage to be on the order of 100 kV.

In the device of FIG. 6, two vacuum pumps 110 and 112 are used to create differential pressures in the electron generation chamber 101 and in the application chamber, respectively. Alternatively, it is possible to create a differential pressure in the electron generation chamber by using a hermetically sealed vacuum and positioning a set of louvers directly outside the electron generation chamber.

FIG. 7 illustrates a device for generating ozone or plasma, in which the barrier separating the electron generation chamber 101 and the reaction chamber 104 includes a secondary electron generating stage 113, according to an illustrative embodiment. The device of FIG. 7 operates identically to the device of FIG. 6, with the exception that instead of having a set of louvers in the barrier separating the electron generation chamber 101 from the reaction chamber 104, the barrier includes a set of tubes 113. The set of tubes 113 may be water cooled and block the direct beam path. This causes surface collisions between the electrons and the tubes 113, creating secondary electrons. In this way, the electron energy distribution function in the reaction chamber can be controlled.

In the device of FIG. 7, two vacuum pumps 110 and 112 are used to create differential pressures in the electron generation chamber 101 and in the application chamber, respectively. Alternatively, it is possible to create a differential pressure in the electron generation chamber by using a hermetically sealed vacuum and positioning a set of tubes directly outside the electron generation chamber.

FIG. 8 illustrates a device for generating ozone or plasma, in which electrons are introduced into the reaction chamber 104 through a nozzle. The device of FIG. 8 operates identically to the device of FIG. 5, with the exception that a nozzle facilitates the introduction of the input gas 105 and the electrons from the electron beam source 102 into the reaction chamber 104. The electron beam is introduced to the reaction chamber 104 through a nozzle while input gas 105 is introduced on either side. Because the gas is directional, the nozzle permits a high density of gas and enhanced differential pumping, in addition, the gas expansion in the nozzle will cool the gas, helping to reduce loss of ozone due to collisions with hot gas due to thermal destruction processes. The throat of the nozzle allows an intense gas and electron beam zone to be created. For this reason, the device of FIG. 8 is similar to the device of FIG. 5 in that lower voltages may be required (on the order of 100V-100(V) than those used by the device FIG. 1. In addition, a secondary electron generating stage may be positioned at or near the nozzle throat to provide better control of the electron energy distribution within the reaction chamber 104.

While various embodiments of the present invention have been shown and described herein, it will be obvious to those skilled in the art that such embodiments are provided by way of example only. Numerous variations, changes, and substitutions will now occur to those skilled in the art without departing from the invention. It should be under stood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for generating a plasma or ozone, comprising:
an electron beam emitter having an electron generation chamber, configured to emit a beam of electrons, and having a barrier at one end of the electron generation chamber, the barrier comprising an electron permeable material to provide a window through which the beam of electrons passes and which seals the electron generation chamber to prevent material from passing out of the electron generation chamber and maintains a differential pressure and a vacuum level;
a reaction chamber arranged proximate the barrier for receiving the beam of electrons and having a passage for allowing a gas to flow through; and
an input gas source for introducing an input gas into the reaction chamber, whereby the input gas may react with the beam of electrons inside the reaction chamber to form an output gas comprising a reactive gas in a form of plasma or a concentration of ozone and the output gas passes from the reaction chamber to a wafer processing chamber.

2. The system of claim 1, further comprising a controller for controlling a current and an accelerating voltage of the electron beam emitter to manipulate characteristics of the beam of electrons to achieve a selected energy distribution inside the reaction chamber.

3. The system of claim 1, further comprising a second electron beam emitter configured to emit a second beam of electrons that passes into the reaction chamber.

4. The system of claim 1, further comprising a cooling channel configured to adjust the temperature inside the reaction chamber.

5. The system of claim 1, further comprising a secondary electron generator arranged to block a path of the beam of electrons and generate secondary electrons.

6. A method for generating a plasma or ozone, comprising:
emitting, by an electron beam emitter having an electron generation chamber, a beam of electrons across a barrier arranged at one end of the electron generation chamber, wherein the barrier comprises an electron permeable material;
provides a window through which the beam of electrons passes;
seals the electron generation chamber to prevent material from passing out of the electron generation chamber; and
maintains a differential pressure and a vacuum level;
introducing, by an input gas source, an input gas into a reaction chamber arranged proximate the barrier for receiving the beam of electrons, whereby the input gas may react with the beam of electrons inside the reaction chamber to form an output gas comprising a plasma or a concentration of ozone; and
passing the output gas from the reaction chamber into a wafer processing chamber.

7. The method of claim 6, further comprising controlling, by a controller, a current and an accelerating voltage of the electron beam emitter to manipulate beam characteristics to achieve a selected energy distribution inside the reaction chamber.

8. The method of claim 6, further comprising emitting, by a second electron beam emitter, a second beam of electrons that passes into the reaction chamber.

9. The method of claim 6, further comprising adjusting, by a cooling channel, the temperature inside the reaction chamber.

10. The method of claim 6, further comprising blocking, by a secondary electron generator, a path of the beam of electrons, thereby generating secondary electrons.
